(19) United States
(12) Patent Application Publication
(10) Pub. No.: US 2021/0397345 A1
(43) Pub. Date: Dec. 23, 2021

(54) MANAGING I/O AMPLIFICATION IN LOG-STRUCTURED MERGE TREES

(71) Applicant: Nutanix, Inc., San Jose, CA (US)

(72) Inventors: Anoop JAWAHAR, Bangalore (IN); Sandeep Kumar MADANALA, Hyderabad (IN); Shyam SANKARAN, Chennai (IN); Yasaswi KISHORE, Bangalore (IN)

(21) Appl. No.: 17/324,042

(22) Filed: May 18, 2021

(30) Foreign Application Priority Data
May 19, 2020 (IN) 202041021000

(51) Int. Cl. G06F 3/06; G06F 9/455

(52) U.S. Cl. CPC G06F 3/061; G06F 3/0665; G06F 3/0641; G06F 2009/4557; G06F 9/45558; G06F 2009/45583; G06F 2009/45575; G06F 3/067

(57) ABSTRACT

Methods, systems, and computer program products for performing inline garbage collection of the portion of a data storage area corresponding to a to-be-deleted key of a key-value pair.

### RELATED APPLICATIONS

The present application claims the benefit of priority to India Patent Application Ser. No. 202041021000 titled “MANAGING I/O AMPLIFICATION IN LOG-STRUCTURED MERGE TREES” filed on May 19, 2020, which is hereby incorporated by reference in its entirety.

### TECHNICAL FIELD

This disclosure relates to key-value storage, and more particularly to techniques for high-performance management of log-structured merge-tree data structures.

### BACKGROUND

Log-structured merge trees (LSM trees) and more specifically, LSM-based key-value (KV) stores have emerged as the preferred choice for update-heavy workloads when compared with B/B+ tree-based KV stores. LSM trees use an append-only mechanism where all updates are treated as new writes. Management of stale keys often includes some form of compaction that strives to remove older entries and reclaim the storage space that was used by the older entries.

Unfortunately, the architecture of the foregoing LSM trees and the architecture of the compaction processing exhibit many deficiencies:

1. Impact on user-facing performance: Compaction is essentially a merge-sort which is a compute, memory, and I/O intensive operation which impacts user-facing operations while the compaction is being performed.

2. Impact on scan performance: In an update/delete-heavy environment, scan performance is poor, at least inasmuch as a scan through keys has to skip over older key-value pairs. This performance degrades further and further as there are more and more files that have not been compacted yet.

3. Impact on scan performance: Read performance is also adversely impacted by the number of files as the number of blocks read is often super-linear with respect to the number of files in the database.

4. Impact on performance sustainability: As the LSM tree grows larger, it gets harder and harder for the compaction processes to keep pace with the LSM tree growth. At some point the compaction rate of stale keys and values may become slower than the deletion rate. This is due primarily to the amount of I/O processing required to do compaction on legacy architectures.

Unfortunately, these issues prevent scalability. What is needed is a technique or techniques that address how to avoid unwanted performance bottlenecks.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and in computer program products for managing I/O amplification in log-structured merge trees, which techniques advance the relevant technologies to address technological issues with legacy approaches. More specifically, the present disclosure describes techniques used in systems, methods, and in computer program products that implements an improved architecture for managing I/O performance in log-structured merge trees. Certain embodiments are directed to technological solutions wherein the storage of LSM keys is provided by a key storage area optimized for key manipulation and wherein the storage of values is provided by a separate block storage area optimized for value manipulation.

The disclosed embodiments modify and improve over legacy approaches. In particular, the herein-disclosed techniques provide technical solutions that address the technical problems associated with LSM tree architectures that store keys and values together, and thus exhibit unwanted performance bottlenecks. Such technical solutions involve specific implementations (i.e., data organization, data communication paths, module-to-module interrelationships, etc.) that relate to the software arts for improving computer functionality. Various applications of the herein-disclosed improvements in computer functionality serve to reduce demands for computer memory, reduce demands for computer processing power, reduce network bandwidth usage, and reduce demands for intercomponent communication. LSM tree architectures that store keys and values together exhibit unwanted performance bottlenecks as a result of high memory usage and high CPU cycles being demanded. These demands are significantly reduced as compared to the memory usage and CPU cycles that would be needed but for implementation of the herein-disclosed architecture that facilitates the storage of LSM keys into a key storage area optimized for key manipulation and separately storing values into a separate block storage area optimized for value manipulation.

Many of the herein-disclosed embodiments for providing an architecture that facilitates the storage of LSM keys into a key storage area optimized for key manipulation and separately storing values into a separate block storage area optimized for value manipulation. are technological solutions pertaining to technological problems that arise in the hardware and software arts that underlie computer clusters. Aspects of the present disclosure achieve performance and other improvements in peripheral technical fields including, but not limited to, hyperconverged computing platform management and high-performance computing.

Some embodiments include a sequence of instructions that are stored on a non-transitory computer readable medium. Such a sequence of instructions, when stored in memory and executed by one or more processors causes the one or more processors to perform a set of acts over an architecture wherein the storage of LSM keys is provided by a key storage area optimized for key manipulation and wherein separate block storage is provided for separately storing values into a storage area optimized for value manipulation.

Some embodiments include the aforementioned sequence of instructions that are stored in a memory, which memory is interfaced to one or more processors such that the one or more processors can execute the sequence of instructions to cause the one or more processors to implement acts over an architecture wherein the storage of LSM keys is provided by a key storage area optimized for key manipulation and wherein separate block storage is provided for separately storing values into a storage area optimized for value manipulation.

In various embodiments, any combinations of any of the above can be combined to perform any variations of acts for architecture, system and method to manage I/O performance in log-structured merge trees, and many such combinations of aspects of the above elements are contemplated.

Further details of aspects, objectives, and advantages of the technological embodiments are described herein, and in the figures and claims.

### BRIEF DESCRIPTION OF THE DRAWINGS

The drawings described below are for illustration purposes only. The drawings are not intended to limit the scope of the present disclosure. This patent or application file contains at least one drawing executed in color. Copies of this patent or patent application publication with color drawings will be provided by the U.S. Patent and Trademark Office upon request and payment of the necessary fee.

FIG. 1A exemplifies an operation flow for high-performance maintenance of a key store when separate from a value store, according to an embodiment.

FIG. 1B exemplifies a storage architecture for high-performance maintenance of log-structured merge trees, according to an embodiment.

FIG. 1C1 and FIG. 1C2 exemplify key-value maintenance operations as implemented in a two-tier storage architecture for high-performance maintenance of log-structured merge trees, according to an embodiment.

FIG. 2 exemplifies unwanted performance bottlenecks.

FIG. 3 exemplifies an LSM tree write path.

FIG. 4 exemplifies an LSM tree read path.

FIG. 5 exemplifies an LSM tree scan path.

FIG. 6 exemplifies an LSM tree compaction path.

FIG. 7 depicts an example set of operational components for implementing architecture, system and method to manage I/O performance in log-structured merge trees, according to an embodiment.

FIG. 8 depicts an example free pool manager as used to implement high-performance I/O in log-structured merge trees, according to an embodiment.

FIG. 9 depicts an example high-performance write path as used for high-performance maintenance of log-structured merge trees, according to an embodiment.

FIG. 10 depicts an example high-performance read path as used for high-performance maintenance of log-structured merge trees, according to an embodiment.

FIG. 11 depicts an example high-performance scan path as used for high-performance maintenance of log-structured merge trees, according to an embodiment.

FIG. 12 depicts an example high-performance compaction path as used for high-performance maintenance of log-structured merge trees, according to an embodiment.

FIG. 13 depicts an example high-performance sorted string table flush path as used for high-performance maintenance of log-structured merge trees, according to an embodiment.

FIG. 14 depicts an example high-performance recovery path as used for high-performance maintenance of log-structured merge trees, according to an embodiment.

FIG. 15 depicts system components as arrangements of computing modules that are interconnected so as to implement certain of the herein-disclosed embodiments.

FIG. 16A, FIG. 16B, and FIG. 16C depict virtualized controller architectures comprising collections of interconnected components suitable for implementing embodiments of the present disclosure and/or for use in the herein-described environments.

### DETAILED DESCRIPTION

Aspects of the present disclosure solve problems associated with LSM trees. These problems are unique to, and may have been created by, various LSM tree architectures that store keys and values together in a manner that exhibits unwanted performance bottlenecks. Some embodiments are directed an architecture that supports storage of LSM keys into a key storage area optimized for key manipulation and separately storing values into a separate block storage area optimized for value manipulation. The accompanying figures and discussions herein present example environments, systems, methods, and computer program products for high-performance log-structured merge trees.

### Overview

Disclosed herein is an architecture that optimizes performance by storing only keys and block IDs in the LSM tree and separately stores the values in a block-store facility. This makes the LSM tree size smaller by orders of magnitude, minimizing the impact of aggressive compaction on front-end I/O and giving us much smoother read/write/scan performance. This design also removes the WAL bottleneck and enables parallel writes with sequential ack, that allows us to fully utilize the disk's I/O bandwidth.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

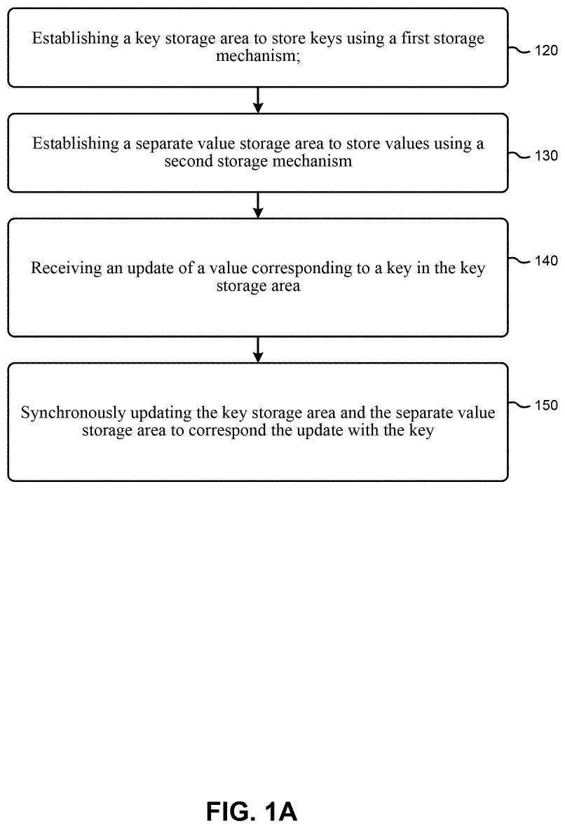

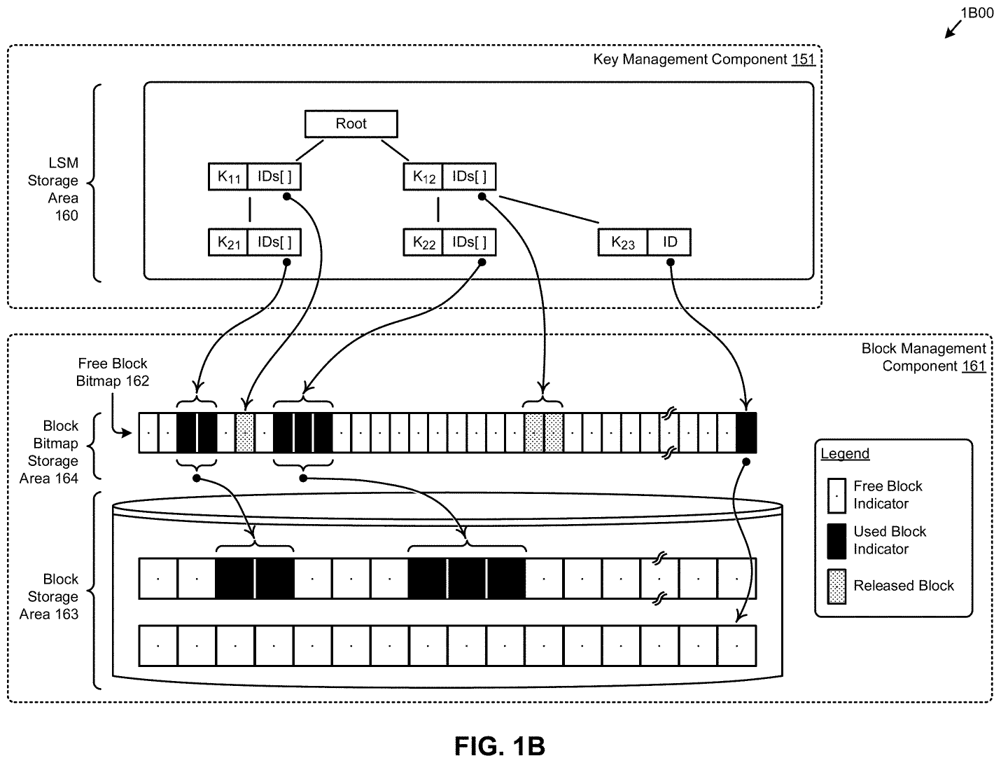

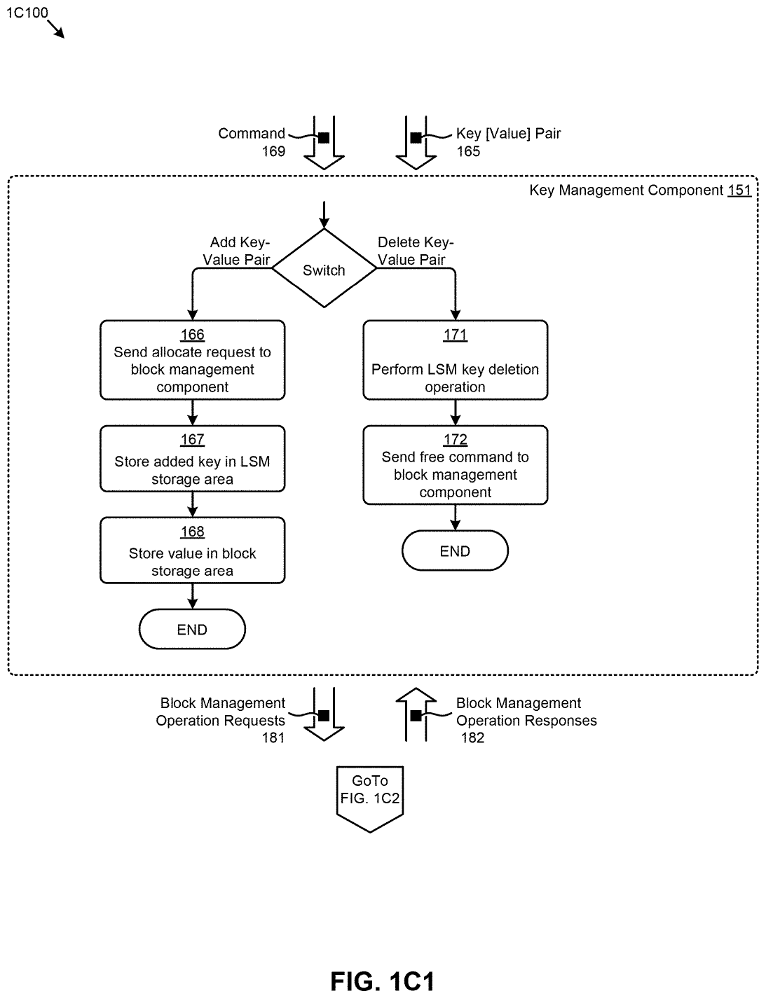

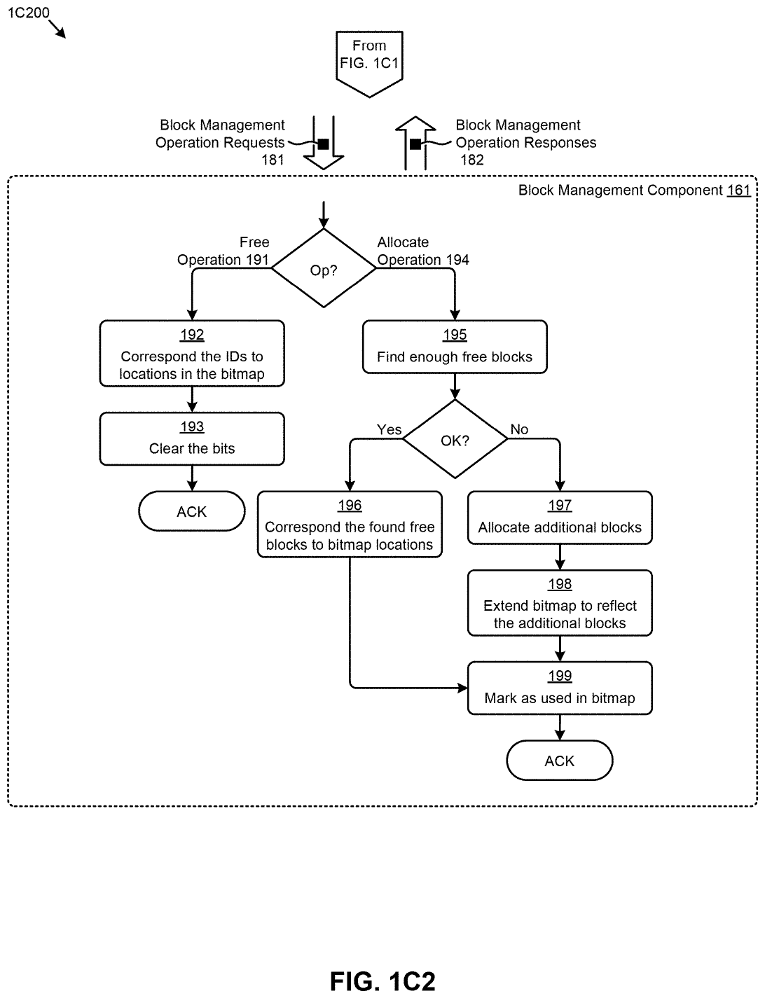

FIG. 1A exemplifies an operation flow for high-performance maintenance of a key store when separate from a value store.

The figure depicts a particular computer-implemented method. As shown the method commences by establishing a key storage area to store keys and a separate value storage area to store corresponding values (step 120). Then, upon receiving a command (step 130) to update a new value that corresponds to a particular key the key storage area and the value storage area are updated synchronously (step 140). In this embodiment, the operations for synchronously updating include indicating a new storage location of the new value in the key storage area and reclaiming a portion of the separate value storage area that corresponds to an older value of the particular key. More particularly, (A) acts for indicating a new storage location of the new value in the key storage area and (B) acts for reclaiming a portion of the separate value storage area are performed in a sequence such as A followed by B or B followed by A. In this sense, and as used herein as pertains to FIG. 1A and infra, the terms synchronous refers to the fact that the aforementioned sequence of A followed by B or B followed by A is not asynchronous. Moreover, neither operations for A nor operations for B are performed by asynchronously running agents (e.g., later-scheduled or later-running post-processes, garbage collectors, etc.).

FIG. 1B exemplifies a storage architecture 1B00 for high-performance maintenance of log-structured merge trees. As an option, one or more variations of storage architecture 1B00 or any aspect thereof may be implemented in the context of the architecture and functionality of the embodiments described herein. The storage architecture 1B00 or any aspect thereof may be implemented in any environment.

As shown, a key management component operates over an key storage area (e.g., LSM storage area 160). The key management component is on communication with a block management component that operates over a block storage area 163. The LSM storage area holds an LSM tree, whereas the block storage area holds a set of blocks.

The blocks in the separate block storage area are indexed or otherwise addressed by LSM storage area. Specifically, and as shown, a given key in the LSM storage area has an association with a set of one or more block IDs. As is known in the art, storing a block ID (e.g., a numeric value such a 1, or 10, or 1000, or 10,000, or 23456789) requires only a few bytes, whereas storage of the data that corresponds to the value associated with a give key may require many thousands of times more bytes. Strictly as one example, a block ID of ‘1’ would require just one byte to represent, whereas a block would normally consume 1024 bytes—a factor of over 1000.

The block management component operates over a bitmap or similar data structure, that keeps track of whether a particular block is ‘free’, or whether a particular block is in use, or whether a block is a previously-used and now released block. In some cases, released blocks or ranges of released blocks contain user data, and as such, may be subject to data cleaning before being reused.

A bit or range of bits of the free block bitmap 162 correspond to physical blocks of the block bitmap storage area 164.

In some embodiments, upon receiving a key and its corresponding value, the key management component, in conjunction with the block management component 161 goes about storing the value in a block storage area contemporaneously with storing the key in a key storage area that is separate from the block storage area. The value (e.g., one or more blocks in the block storage area) can be retrieved by first accessing the key to find the location (e.g., block ID) in the block storage, then accessing that location in the block storage.

The value can be accessed any number of times over any time period however, at some point a client (e.g., virtual machine or other computing process) may want to delete the value, and thus the key should also be deleted. As such, upon receipt by the key management component of a command that indicates that a value in the block storage area is to be reclaimed—which also means that the data storage of the key in the key storage area is also to be reclaimed—the key management component will reclaim the data storage of the key. Such reclaiming of the data storage of the key can be performed before returning an acknowledgement to the computing process that the command has been performed inline. More specifically, since the key storage has been reclaimed inline, effectively removing access to the value, then the storage locations that hold the value in the block storage area can be reclaimed and reused at a later point in time. To facilitate this, the key management component will store a designation (e.g., block ID) or designations (a range or list of block IDs) of the storage locations that hold the value in the block storage area into an in-memory list, which in-memory list can be processed by the block management component.

In some cases an index to the then-current keys is formed by a plurality of sorted string files that may expand (e.g., as keys are added) and contract (e.g., as keys are deleted). Accordingly when deleting a key, it can happen that two or more sorted string files are compacted. This is a compute-efficient task, and as such, the compaction can be carried out before returning to the computing process (e.g., before sending back an acknowledgement, or before returning execution control to the computing process). To further reduce latency of deleting a key and performing reclamation of the data storage corresponding to the deleted key, the index or portions thereof can be cached in memory. As such, the computing actions needed to completely manage a key deletion such that no separate garbage collection task is needed, can be completed with so few computing cycles, and with few or zero disk accesses that the entire task of key deletion can be performed inline. In this case, inline means that all of the computing actions needed to completely manage a key deletion such that no separate garbage collection task is needed are performed before any explicit context switching back to the computing process that raised the command to delete the key-value pair.

In some embodiments, the block management component can process the foregoing in-memory list such that entries of the list are parsed to identify whatever portions of the block storage area had corresponded to a reclaimed key. In this manner, the portions of the block storage area that had corresponded to a reclaimed key are delivered to a free pool manager. The manager can keep track of free blocks. In some cases the block management component will zero-out the portion of the block storage area corresponding to the reclaimed key.

Furthermore, for purposes of fast crash-consistent recovery of a failed system, the block management component might persist details pertaining to management of the block storage area of a reclaimed key in a write ahead log. Alternatively, or additionally, block management component may indicate, in free block bitmap 162, whatever portions of the block storage area had been reclaimed (e.g., since those portions corresponded to the value of a reclaimed key). For example, the block or blocks of the block storage area that had been reclaimed can be identified as free by clearing bits in a free block bitmap.

FIG. 1C1 exemplifies key-value maintenance operations 1C100 as implemented in a two-tier storage architecture for high-performance maintenance of log-structured merge trees. As an option, one or more variations of key-value maintenance operations 1C100 or any aspect thereof may be implemented in the context of the architecture and functionality of the embodiments described herein. The key-value maintenance operations 1C100 or any aspect thereof may be implemented in any environment.

As shown, the key management component 151 receives a command 169 and a key, and optionally a value that corresponds to the given key (e.g., as depicted by key [value] pair 165. The command may be to add the key-value pair to the LSM tree, or the command may be to delete (and reclaim) spaces allocated to the key value pair. In the former case, to add a key-value pair to the LSM tree, the key management component will send an allocate request (step 166) to the block management component (see FIG. 1C2). Once the block management component has acknowledged the request, the added key can be stored in the LSM storage area (step 167) and the value can be stored (step 168) in the block storage area 163.

In the latter case, to delete a key-value pair, the key management component will perform an LSM key deletion operation (step 171) over the LSM storage area and then sends a free block request to the block management component (step 172).

FIG. 1C2 exemplifies key-value maintenance operations 1C200 as implemented in a two-tier storage architecture for high-performance maintenance of log-structured merge trees. As an option, one or more variations of key-value maintenance operations 1C200 or any aspect thereof may be implemented in the context of the architecture and functionality of the embodiments described herein. The key-value maintenance operations 1C200 or any aspect thereof may be implemented in any environment.

As shown, the block management component 161 of FIG. 1C2 receives block management operation requests 181 (e.g., from the key management component) and determines the nature of the requested operation. The result of processing a block management operation request includes returning a block management operation response 182 to the caller.

If the request involves a free operation 191, then the block management component corresponds the IDs given in the request to locations in the bitmap. For example, if the ID is ‘2’, then the second bit (e.g., in the second position) of the bitmap is located. In some cases, a location is first located to a particular byte (e.g., on an 8-bit boundary). In some cases, a location is first located to a particular word (e.g., on a 16-bit or 32-bit or 64-bit boundary). In some cases a bit offset is represented by a mask value.

Once a location in the bitmap has been calculated (step 192) the bit or range of bits can be cleared (step 193), where a cleared bit represents that the block or blocks that correspond to the range of cleared bits are deemed to be free.

If the request is an allocate operation 194, then the block management component sets about to find enough free blocks (step 195) to satisfy the request. If there are indeed enough free blocks to satisfy the request (see the “Yes” branch”) then the requested and found blocks are corresponded to bitmap locations, and those bits are marked as in-use (step 196). On the other hand, if not enough blocks are found, then the block management component sets about to allocate additional blocks (step 197) and extend the bitmap accordingly (step 198) to reflect the tracking of the newly-allocated blocks. Those blocks are then corresponded to bitmap locations in the bitmap, and those bits are marked as in-use (step 199).

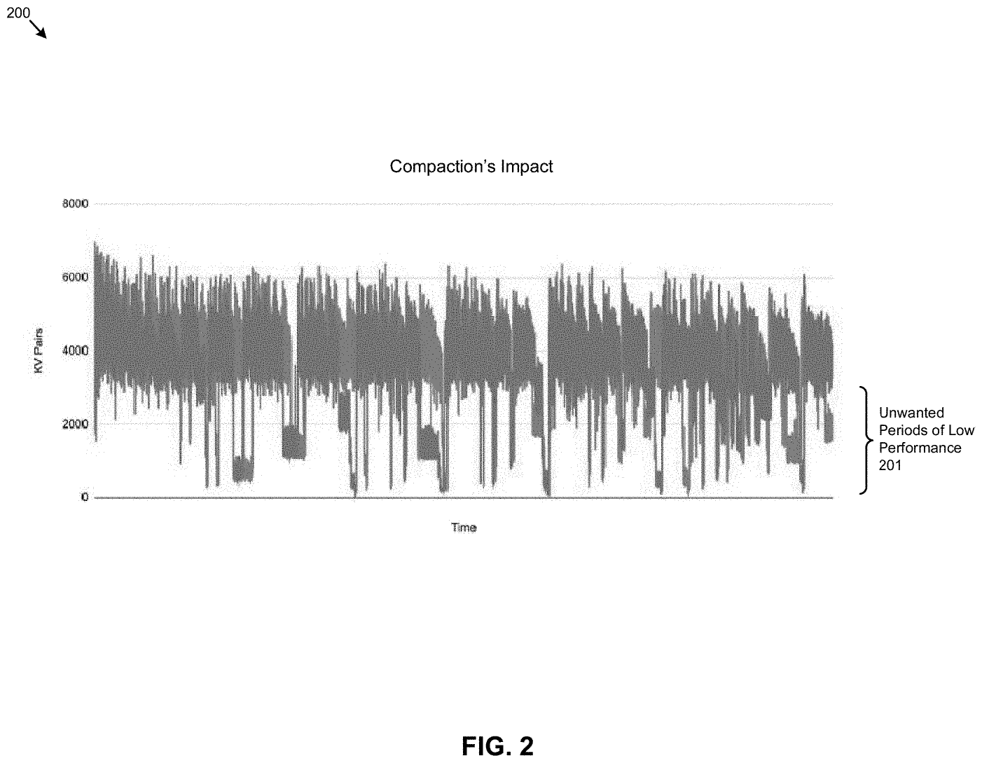

FIG. 2 exemplifies unwanted performance bottlenecks 200. At scale, read, write, and scan performance of LSM trees degrade due to compaction not being able to keep up with the number of incoming writes. Tuning the LSM to perform compaction aggressively causes significant performance degradation to user-facing operations. As shown in this example, tuning the LSM to perform compaction aggressively causes unwanted periods of low performance 201.

The herein-disclosed embodiments serve to reduce the impact that compaction has on CPU usage, memory usage and I/O performance by modifying the way keys and values are stored and managed. This also leads to faster compaction and faster read/write/scans at scale.

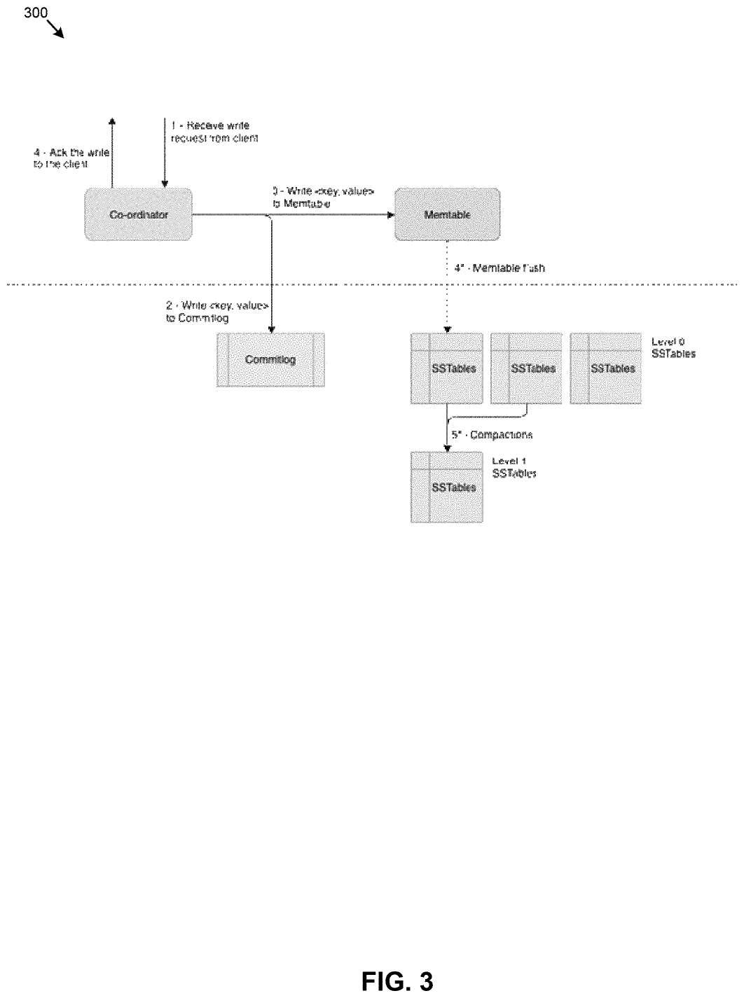

FIG. 3 exemplifies an LSM write path 300. An LSM tree is one of the most popular architectures used for key-value stores in many major NO-SQL databases in production. It consists of 3 major components—Commitlog, Memtable and SSTables. The Commitlog and SSTables are on-disk while the Memtable is an in-memory data structure. The Commitlog is an append-only file which is used as a log for recovery purposes. The Memtable is used to absorb writes and speed up the write path. The SSTables, which stand for Sorted String tables, are sorted, immutable files which store all the key-value pairs persistently. The SSTables are sometimes divided into multiple levels, with each level having larger SSTables than the one before it.

An LSM tree's write/update path is simple and is predominantly why they are preferred over other structures. An update to a key is treated as a new write and does not update the previous value for the key. This gives the advantage of writes being fast as it does not search for the previously written value and then update it.

The write path involves appending the Commitlog file with the key-value pair and then updating the Memtable. Note that all writes have to be sequentially written to the Commitlog and if writes come in parallel, they will be serialized while writing to it. Once the Memtable or the Commitlog crosses a predefined limit, the Memtable content is written into the disk(flushing) to create an SSTable. The SStable contains the key-value pairs sorted based on the key. However, since updates to keys are treated as new writes, there might be duplicate entries for the key in multiple SStables where the newest SStable always has the right value for the key. To clean up the older entries, LSM trees perform compaction which is described herein.

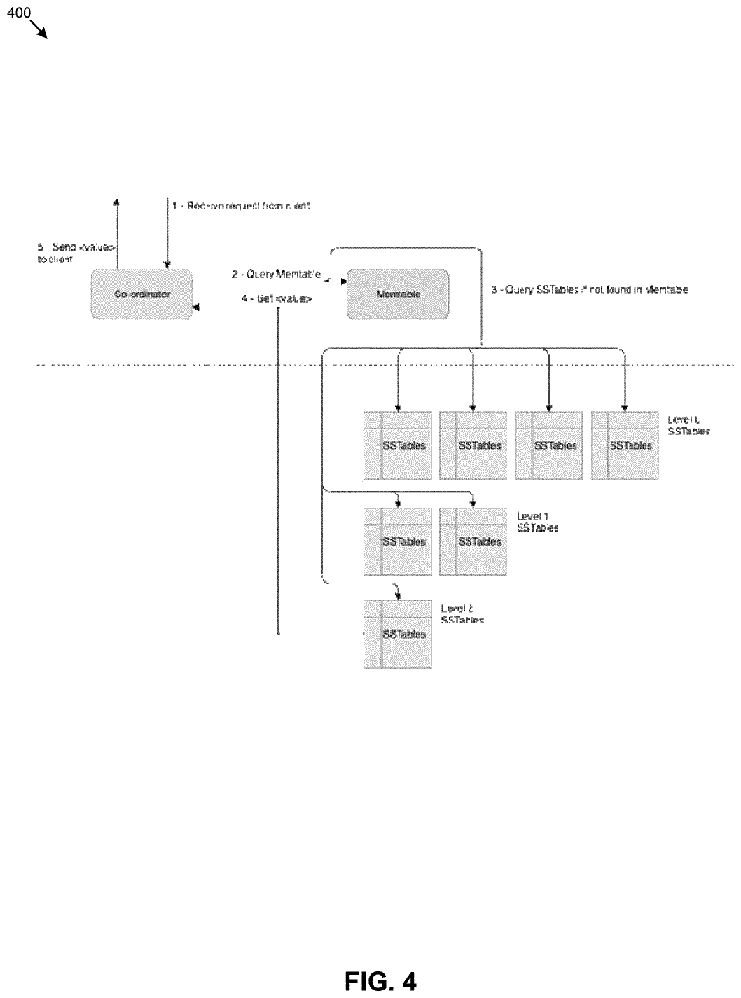

FIG. 4 exemplifies an LSM read path 400. An LSM's read is more involved process. It requires searching for the value of the key in the Memtable and multiple SSTable files. This is the consequence of updates being treated as new writes and leaving existing values to be cleaned up by compaction. Hence the LSM does all the querying in parallel to avoid wasting time on the Memtable or a single SSTable.

### Common Optimizations for the Read Path Include:

When accessing sorted string tables, consult the most recent SStables first since the newest entry is always the right one. Additionally or alternatively, apply bloom filters to filter out SSTables. Bloom filters provide the guarantee that if it returns false, then the key definitely does not exist in the SSTable, but if it returns true, then it might still not exist in the SSTable.

The efficiency of the read path depends on the number of SSTable files in the LSM since there might have to be at least one disk I/O per SSTable file. So the size amplification of the LSM tree directly impacts the read performance of the LSM tree.

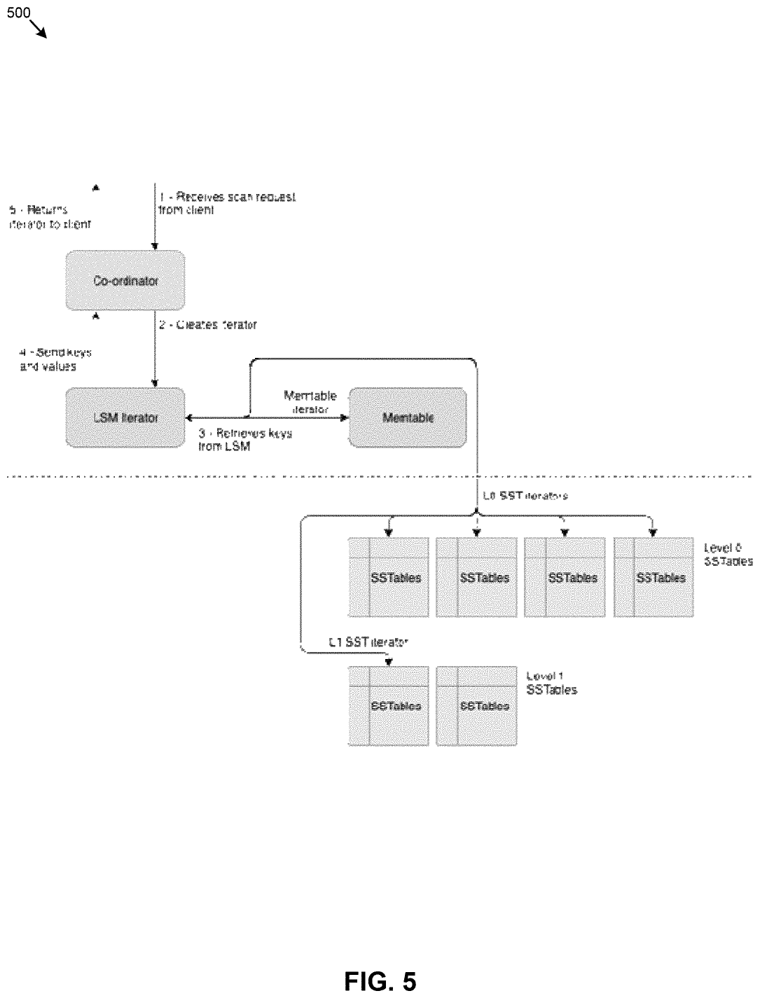

FIG. 5 exemplifies an LSM scan path 500. Scan operations on the LSM involves finding all valid key-value pairs in the database, usually between a user-defined range. A valid key-value pair is one which has not been deleted. Note that while each SSTable file and the memtables are sorted structures, in some embodiments, they can have overlapping ranges. As such, there is no sorted view of the entire database.

The LSM iterator is responsible for generating this view for the client. It iterates through the keys for every SSTable and is also responsible for discarding the obsolete key-value pairs returned from older SSTables which have not been compacted yet.

Scans are generally more challenging to solve in an LSM based key-value store than a B-tree based store due to the presence of obsolete key-value pairs in older SSTables that need to be skipped. Note that scan performance is also directly tied to the number of SSTable files and the amount of obsolete key-value pairs present in the database. Reading obsolete key-value pairs is an impact to performance as it is a waste of CPU, memory and I/O bandwidth.

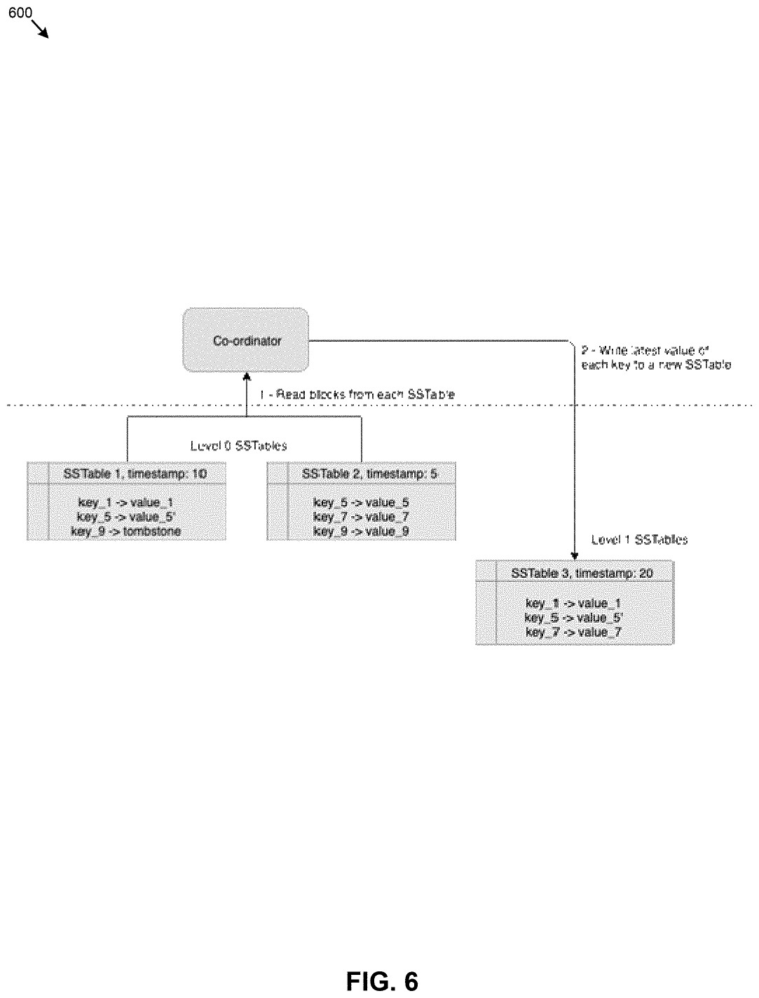

FIG. 6 exemplifies an LSM compaction path 600. Compaction is the key process that is responsible for cleaning up obsolete key-value pairs and reducing the number of SSTables in the database.

### Compaction Steps

Compaction steps may include: Selecting the SSTable files to perform compaction for—there are various heuristics that different implementations consider, then reading all the key-value pairs from the SSTables into memory and merge them together to form a single sorted stream. This involves removing the obsolete key-value pairs due to updates or deletes.

Next, write the single sorted stream as a new SSTable file and delete the old SSTable files which are now obsolete.

Compaction is a fairly CPU/memory intensive process since it maintains a large number of keys and has to perform merge-sort across multiple incoming sorted streams. It is also extremely I/O intensive since it can potentially generate read and write working sets which encompass the entire database and in-turn severely impact user-facing read/write/scan operations.

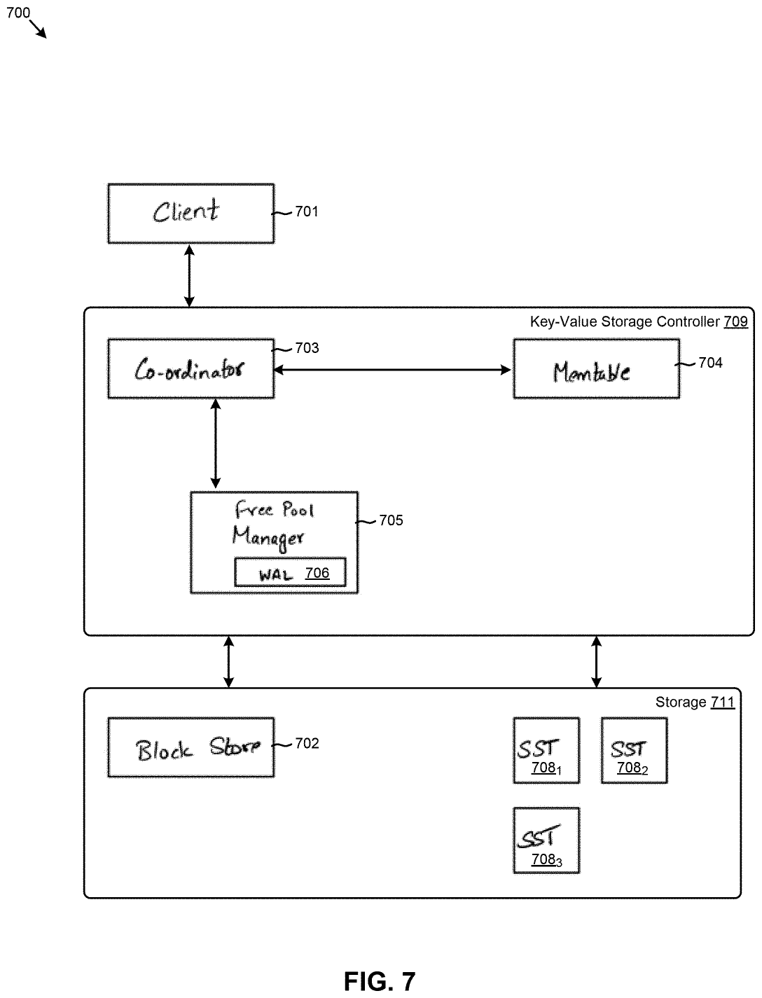

FIG. 7 depicts an example set of operational components 700 for implementing architecture, system and method to manage I/O performance in log-structured merge trees. As an option, one or more variations of operational components 700 or any aspect thereof may be implemented in the context of the architecture and functionality of the embodiments described herein. The operational components 700 or any aspect thereof may be implemented in any environment.

As shown, the operational components include a client 701, a co-ordinator 703, a memtable 704, a free pool manager 705 that interfaces to a write ahead log (WAL 706), a block store 702 and several instances of sorted string tables (e.g., SST 7081, SST 7082, and SST 7083). The client can be any computing process, possibly a virtual machine or executable container or other process of a virtualization system. The client can make calls to a key-value storage controller 709, which key-value storage controller can in turn be interfaced with storage 711. In some embodiments, some or all of the instances of the sorted string tables (e.g., some or all of SST 7081, SST 7082, and SST 7083) are held in persistent storage. In some embodiments, some or all of the instances of the sorted string tables (e.g., some or all of SST 7081, SST 7082, and SST 7083) are held in computer memory (e.g., semiconductor memory). In some embodiments, some or all of the instances of the sorted string tables (e.g., some or all of SST 7081, SST 7082, and SST 7083) are held in persistent storage while at the same time, copies or updated versions of the string tables are held in memory (e.g., in a cache memory).

Disclosed herein are techniques that reduce the I/O impact of background operations which in turn will also speed up user-facing operations. Storing values in a “Block store” (e.g., backed by a vDisk) and separately storing merely the block ids (and any remainder value) in the LSM tree structure.

This reduces the size of the LSM which will enable high-performance compaction, which leads to faster read and scans. The architecture also handles deletes and overwrites of the values that are performed inline in the compaction path thereby removing the need for post processing to separately compacting the values.

### Block-Store

Block-store is a commonly used software that is used to manage storage of data of a linear address space like a file/disk/memory. It has the ability to read/write/allocate/deallocate blocks of a fixed size on the given linear address space. It has the following abilities/responsibilities:

Block allocation: The allocator has the ability to know which parts of the linear space is free/currently in use and when an application requests for ‘X’ number of blocks, return the free blocks correctly.

Block deallocation: The deallocator has the ability to mark a particular set of blocks specified by the application as ‘free’ and make them available for allocation again.

Read/Write—The read/write paths provide the application an interface to read/write to the allocated blocks.

Additionally, the block-store has the ability to maintain crash consistency, for example if blocks 1,2,3 are allocated from it and then there is a crash immediately after, it has to remember which blocks have been allocated/deallocated.

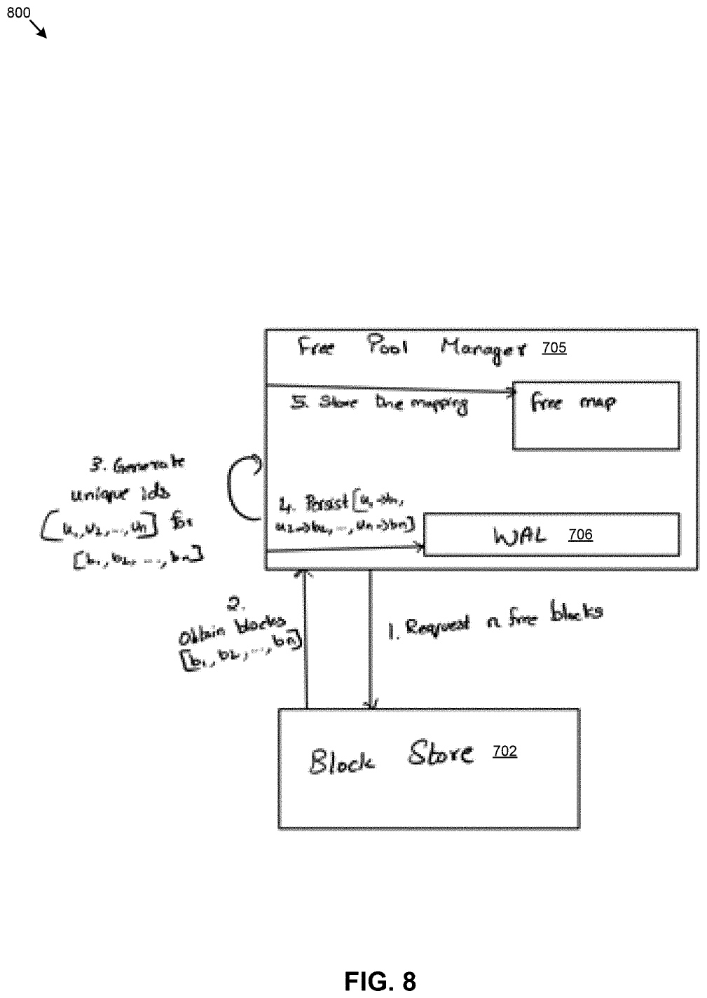

FIG. 8 depicts an example free pool manager implementation 800 as used to implement high-performance I/O in log-structured merge trees. As an option, one or more variations of free pool manager implementation 800 or any aspect thereof may be implemented in the context of the architecture and functionality of the embodiments described herein. The free pool manager implementation 800 or any aspect thereof may be implemented in any environment.

### Free Pool Manager

The FreePoolManager is another component of the overall architecture which is configured to manage all background operations related to block management and recovery. Since allocation/deallocation of blocks needs to be crash-consistent, this requires two additional writes in the allocation/deallocation path. To avoid additional performance hit in the write path, the block allocation is situated in a background task. The allocated blocks are cached in the FreePoolManager to ensure that these blocks are readily available to consume for the front-end operations.

FIG. 8 indicates how the block allocation occurs in the FreePoolManager. The Block allocation algorithm has the following components and functions.

The FreePoolManager requests for ‘n’ free blocks at a time from Block-store. The request is made when the FreePoolManager is running low on blocks. The Block-store allocates new blocks and sends the block-ids to the FPM. The FPM assigns a ‘unique-id’ to each one of the blocks which will decide the order in which these blocks are written to. The FPM persists these unique-id to block-id mapping in an internal write ahead-log for crash consistency as well as in-memory which serves as a cache to serve foreground writes.

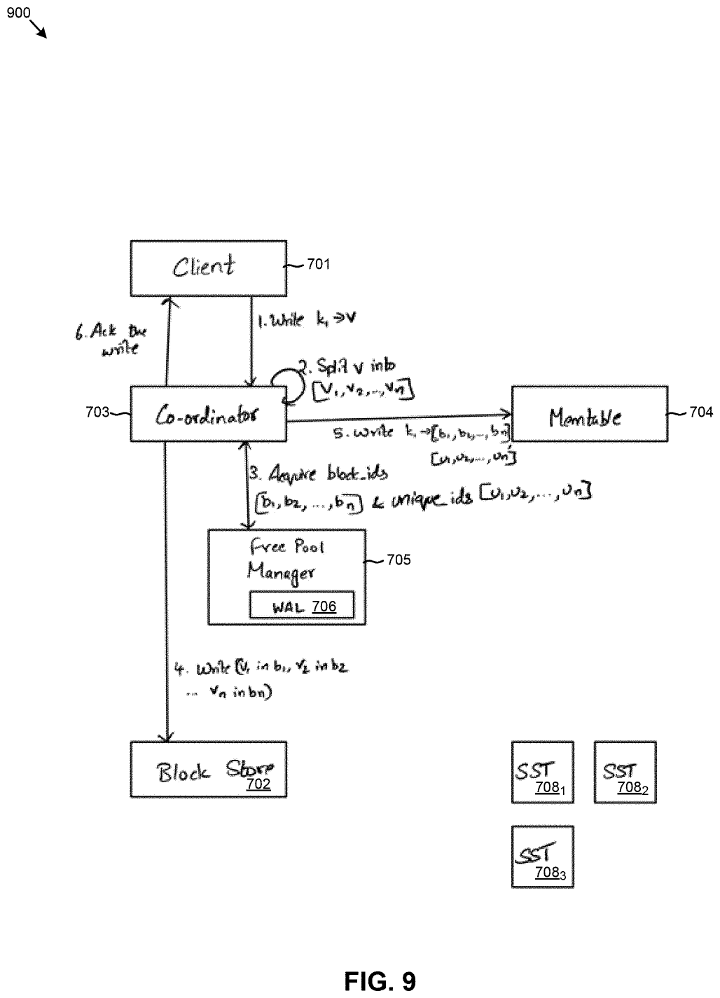

FIG. 9 depicts an example high-performance write path 900 as used for high-performance maintenance of log-structured merge trees. As an option, one or more variations of high-performance write path 900 or any aspect thereof may be implemented in the context of the architecture and functionality of the embodiments described herein. The high-performance write path 900 or any aspect thereof may be implemented in any environment.

This fundamentally changes the write path since now keys and values are written separately into 2 different locations—the LSM and the Block-store. This implies that there are 2 writes per key-value pair. However such writes can happen in parallel and hence essentially the latency cost is only the latency cost of only the longer write.

### Write Algorithm

Step 1—Request the required number of blocks from FreePoolManager depending on the size of the value. Store the Block-ids in memory. Steps 2 and 3—Identify the key and the value and then split the key-value into individual blocks. Step 4—Create a serialized record that contains [value, size] and calculate the checksum of this record per block. Step 5a—Append the checksum to the serialized record and write it to Block store. Step 5b—Write the key, [Block-ids], [unique-ids] into the LSM tree.

Note that step 5a and 5b can happen in parallel so the latency of doing 2 writes is mitigated to some extent due to this.

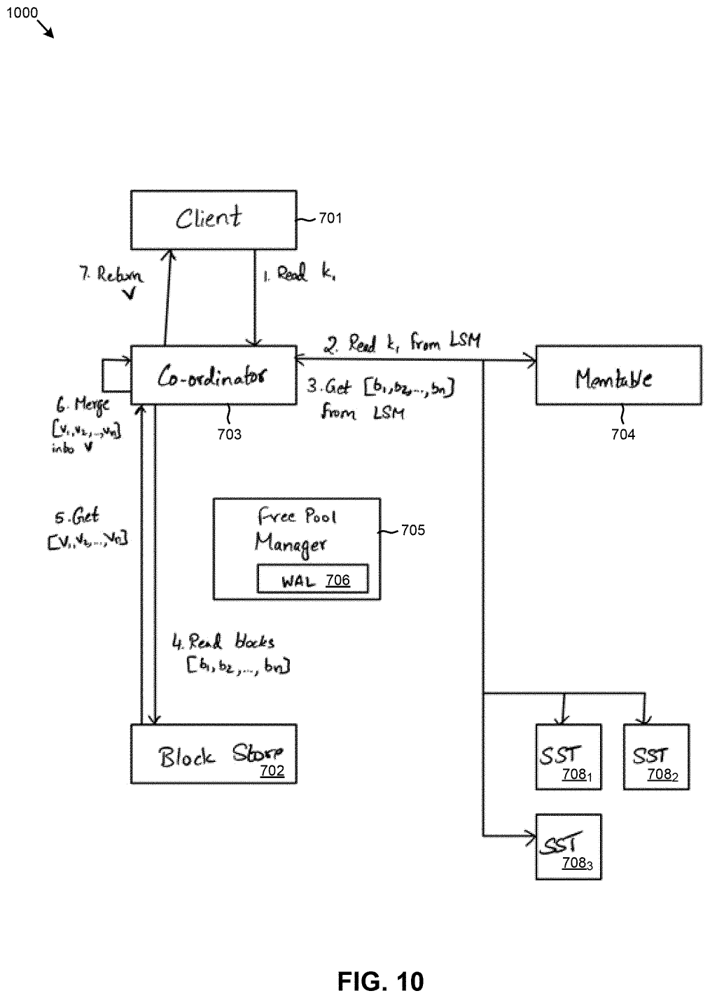

FIG. 10 depicts an example high-performance read path 1000 as used for high-performance maintenance of log-structured merge trees. As an option, one or more variations of high-performance read path 1000 or any aspect thereof may be implemented in the context of the architecture and functionality of the embodiments described herein. The high-performance read path 1000 or any aspect thereof may be implemented in any environment.

In the read path, a reference is made to the LSM to find where the value is and then read the actual value from Block-store. The read algorithm is as follows: Step 1—Lookup the key from the LSM tree and obtain the Block-ids. Step 2—Lookup the partial-values from the Block-store using the Block-ids in parallel. Step 3—Merge all the partial-values and return the value back to the client.

Note that with this architecture there are many fewer S Stables and thus it is often possible to cache most of the SSTs in memory. This can make the I/O cost for Step 1 zero and guarantee that every lookup can happen in a single I/O operation to Block store.

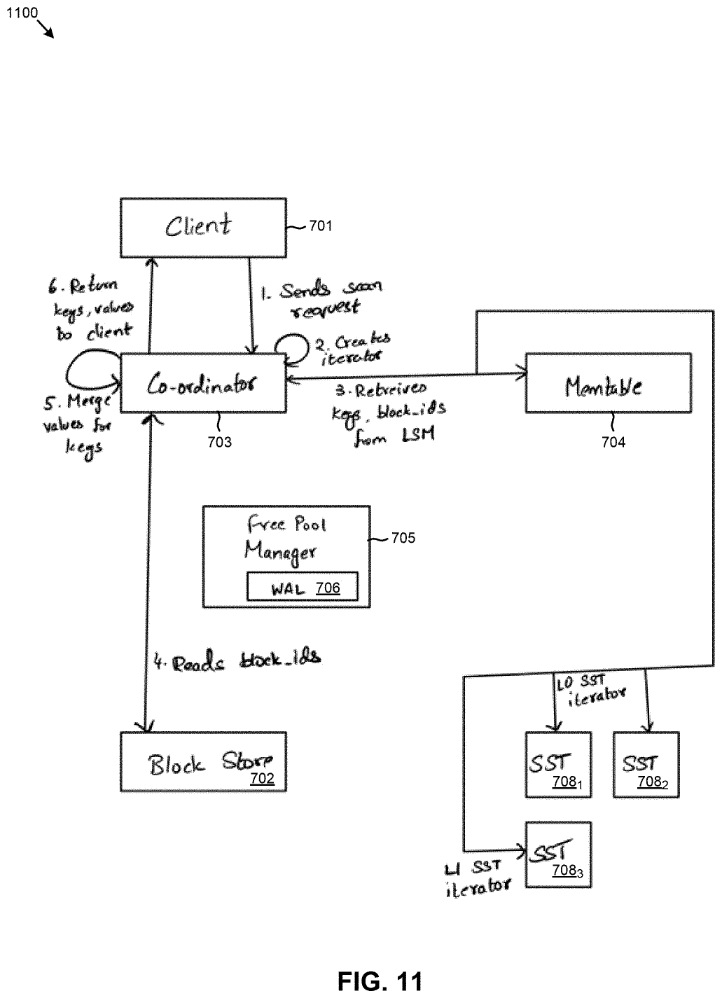

FIG. 11 depicts an example high-performance scan path 1100 as used for high-performance maintenance of log-structured merge trees. As an option, one or more variations of high-performance scan path 1100 or any aspect thereof may be implemented in the context of the architecture and functionality of the embodiments described herein. The high-performance scan path 1100 or any aspect thereof may be implemented in any environment.

Scans or key-based iteration works in a very similar fashion to LSM scans with one additional step. Each valid key returned by the LSM iterator, needs to be looked up from the Block-store as well and merged before returning to the client.

The detailed scan algorithm for a given range (keyX, keyY) is as follows:

Step 1—Create the LSM iterator. This iterator uses the standard LSM scan algorithm to return valid keys. Step 2—Seek to the first valid key that comes after ‘keyX’. Step 3—Iterate through every valid key returned by the LSM iterator and lookup the value from Block-store. Step 4—Merge the valid keys returned by the LSM iterator and the corresponding values from Block-store and return to the client.

Improvements to the Scan path occur in Step 2 and 3 where the cost of getting the next valid key is dependent on how many garbage/duplicates are present in the LSM. This will be much lesser in a purpose-built database engine, since architecturally a purpose-built database engine ensures that compaction is much quicker and is able to iterate through keys much faster in the LSM. Some embodiments perform a separate lookup per valid key, which can potentially increase the cost of scans as well since it translates to random I/O on the device instead of sequential. However on modern storage systems where random I/O is catching up with sequential I/O performance, this cost should be minimal.

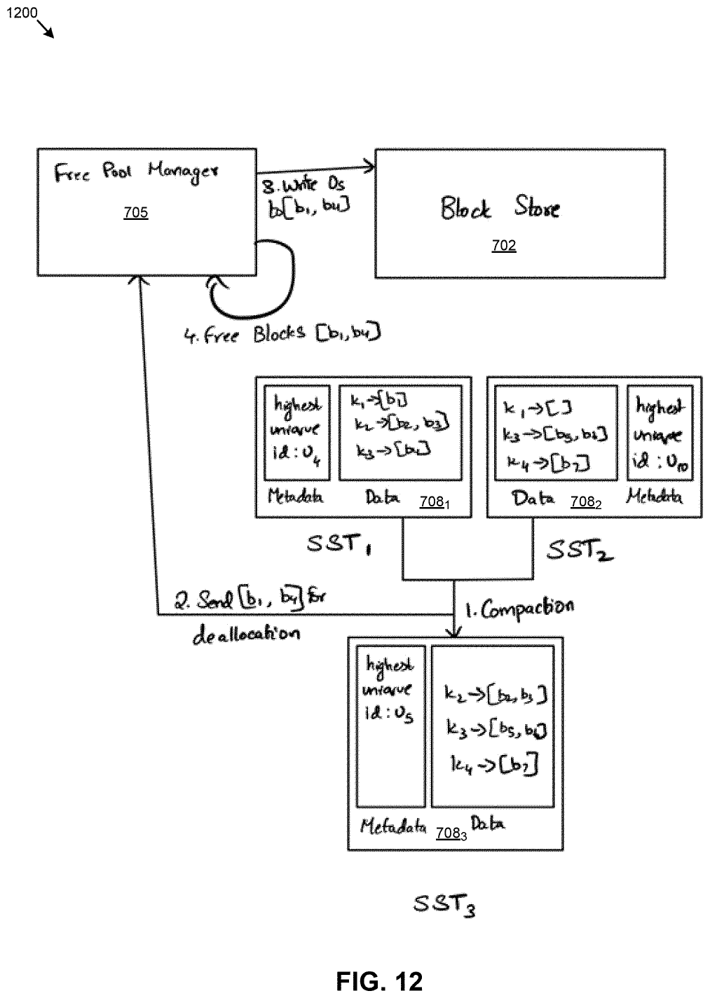

FIG. 12 depicts an example high-performance compaction path 1200 as used for high-performance maintenance of log-structured merge trees. As an option, one or more variations of high-performance compaction path 1200 or any aspect thereof may be implemented in the context of the architecture and functionality of the embodiments described herein. The high-performance compaction path 1200 or any aspect thereof may be implemented in any environment.

The compaction workflow is responsible for cleaning up garbage in the system and is critical for read and scan performance. Given the architecture of the foregoing purpose-built database engine, compaction now has the additional step of garbage collecting the value from Block-store as well.

The following steps are followed during compaction to reclaim space inline: Step 1—While merging two SST files, add the blocks where every stale key's value is stored into an in-memory list. Step 2—Once the new SST file has been created, send all the stale blocks to the FreePoolManager. Step 3—The FreePoolManager has the responsibility of zeroing these blocks to avoid stale data coming back. Step 4—Once the zeroing out is complete, the blocks are added back to the free-list in the Free pool manager which involves persisting these in its internal WAL.

Note that the Block-store GC happens only when keys are actually overwritten/deleted. In the usual LSM architecture, the value write amplification can grow irrespective of the amount of deletes or overwrites in the system however it may be bounded by the churn in the system.

Since the amount of I/O compaction does is also now only the keys, this can improve compaction performance by an order of magnitude in I/O bound workloads and in turn enable faster read/scan performance.

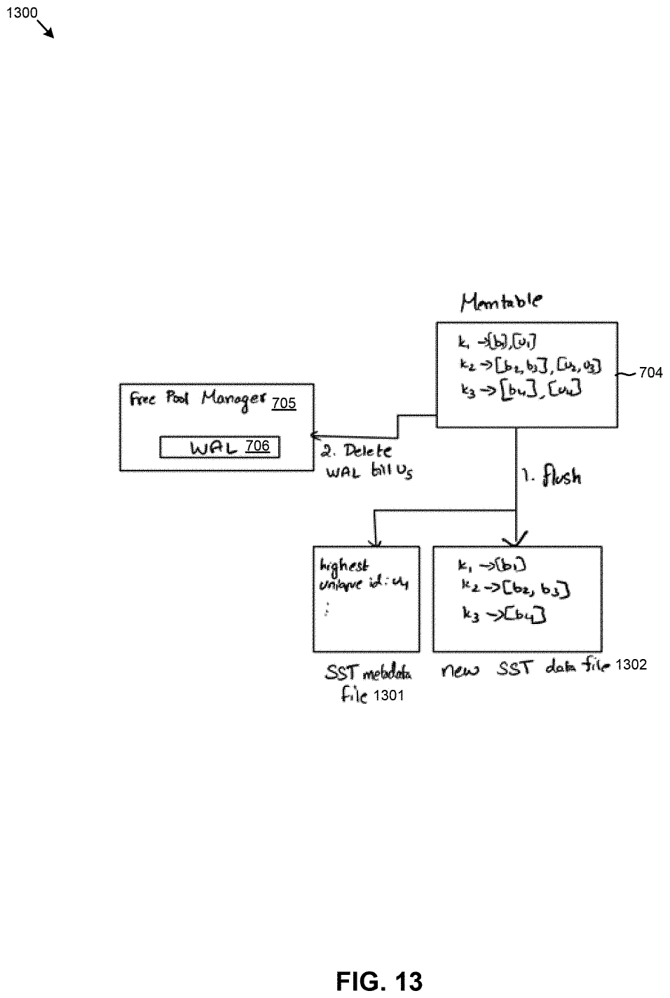

FIG. 13 depicts an example high-performance sorted string table flush path 1300 as used for high-performance maintenance of log-structured merge trees. As an option, one or more variations of high-performance sorted string table flush path 1300 or any aspect thereof may be implemented in the context of the architecture and functionality of the embodiments described herein. The high-performance sorted string table flush path 1300 or any aspect thereof may be implemented in any environment.

Flush is the process using which a new SST data file 1302 is generated in an LSM. Accordingly, a mechanism is provided to let the FPM know that some of the unique id->block-id mappings it has stored in its internal WAL can be garbage collected to enhance recovery time.

### Flush Algorithm

Flush the memtable into a new SSTable (This is the same process as the older architecture). In the SST metadata file 1301 (commonly referred to as Manifest) persist the highest unique id of this SST. Then notify the FPM of the highest unique-id that has been flushed down in the new SST. The FPM removes all unique-id mappings until the ‘highest unique-id’ which has been flushed from its persistent storage or WAL.

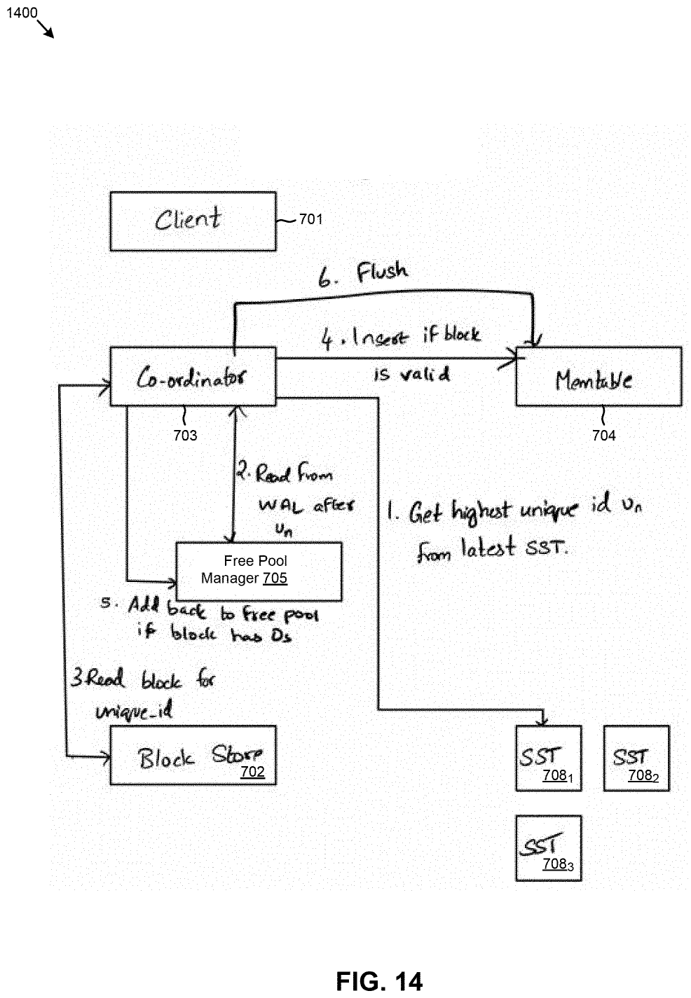

FIG. 14 depicts an example high-performance recovery path 1400 as used for high-performance maintenance of log-structured merge trees. As an option, one or more variations of high-performance recovery path 1400 or any aspect thereof may be implemented in the context of the architecture and functionality of the embodiments described herein. The high-performance recovery path 1400 or any aspect thereof may be implemented in any environment. Recovery is improved in this architecture since the WAL component in the LSM completely unnecessary. Instead, merely keep track of which key-value pairs were previously present in the in-memory structure of the LSM (memtable) before crashing, and come back to the same state on bootup. This is necessary to maintain crash consistency.

### Additional Embodiments of the Disclosure

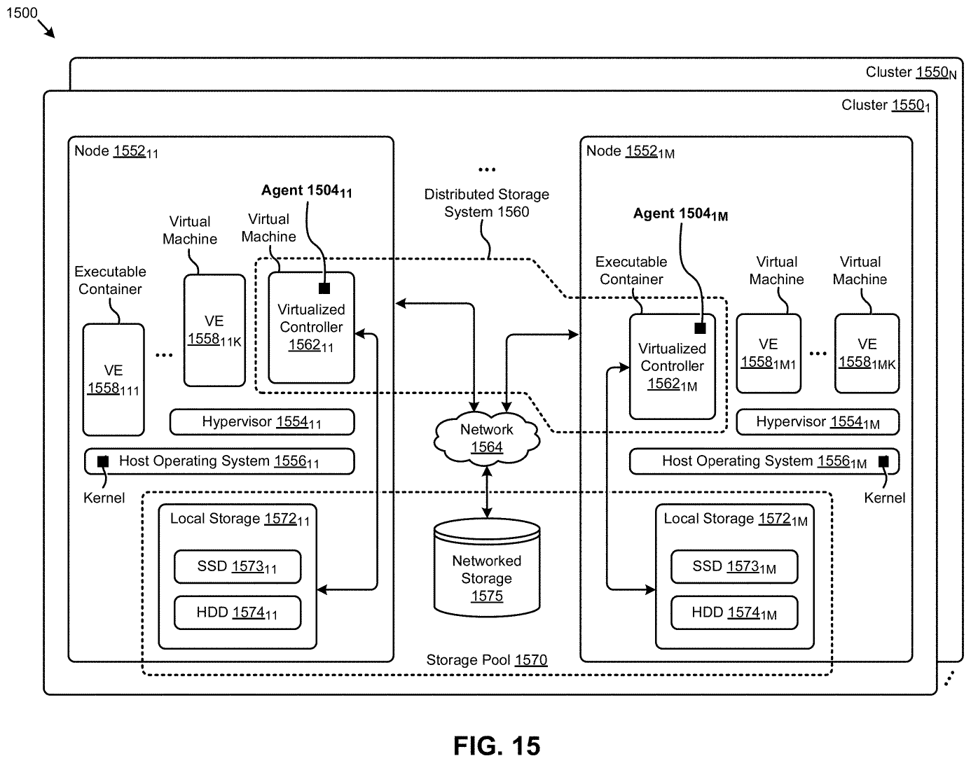

FIG. 15 depicts system components as arrangements of computing modules that are interconnected so as to implement certain of the herein-disclosed embodiments. The partitioning of system 1500 is merely illustrative and other partitions are possible. The shown distributed virtualization environment depicts various components associated with instances of distributed virtualization systems (e.g., hyperconverged distributed systems) that can be used to implement the herein disclosed techniques. Specifically, the distributed virtualization environment 1500 comprises multiple clusters (e.g., cluster 1550₁, . . . , cluster 1550_{N}) comprising multiple nodes that have multiple tiers of storage in a storage pool. Representative nodes (e.g., node 1552₁₁, . . . , node 1552_{1M}) and storage pool 1570 associated with cluster 1550₁ are shown. Each node can be associated with one server, multiple servers, or portions of a server. The nodes can be associated (e.g., logically and/or physically) with the clusters. As shown, the multiple tiers of storage include storage that is accessible through a network 1564, such as a networked storage 1575 (e.g., a storage area network or SAN, network attached storage or NAS, etc.). The multiple tiers of storage further include instances of local storage (e.g., local storage 1572₁₁, . . . , local storage 1572_{1M}). For example, the local storage can be within or directly attached to a server and/or appliance associated with the nodes. Such local storage can include solid state drives (SSD 1573₁₁, . . . , SSD 1573_{1M}), hard disk drives (HDD 1574₁₁, . . . , HDD 1574_{1M}), and/or other storage devices.

As shown, any of the nodes of the distributed virtualization environment 1500 can implement one or more user virtualized entities (e.g., VE 1558₁₁₁, . . . , VE 1558_{11K}, . . . , VE 1558_{1M1}, . . . , VE 1558_{1MK}), such as virtual machines (VMs) and/or executable containers. The VMs can be characterized as software-based computing “machines” implemented in a hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 1556₁₁, . . . , host operating system 1556_{1M}), while the VMs run multiple applications on various respective guest operating systems. Such flexibility can be facilitated at least in part by a hypervisor (e.g., hypervisor 1554₁₁, . . . , hypervisor 1554_{1M}), which hypervisor is logically located between the various guest operating systems of the VMs and the host operating system of the physical infrastructure (e.g., node).

As an alternative, executable containers may be implemented at the nodes in an operating system-based virtualization environment or container virtualization environment. The executable containers are implemented at the nodes in an operating system virtualization environment or container virtualization environment. The executable containers comprise groups of processes and/or resources (e.g., memory, CPU, disk, etc.) that are isolated from the node host computer and other containers. Such executable containers directly interface with the kernel of the host operating system (e.g., host operating system 1556₁₁, . . . , host operating system 1556_{1M}) without, in most cases, a hypervisor layer. This lightweight implementation can facilitate efficient distribution of certain software components, such as applications or services (e.g., micro-services). Any node of a distributed virtualization environment 1500 can implement both a hypervisor-assisted virtualization environment and a container virtualization environment for various purposes. Also, any node in a distributed virtualization environment can implement a virtualized controller to facilitate access to storage pool 1570 by the VMs and/or the executable containers.

As used in these embodiments, a virtualized controller is a collection of software instructions that serve to abstract details of underlying hardware or software components from one or more higher-level processing entities. A virtualized controller can be implemented as a virtual machine, as an executable container, or within a layer (e.g., such as a layer in a hypervisor).

Multiple instances of such virtualized controllers can coordinate within a cluster to form the distributed storage system 1560 which can, among other operations, manage the storage pool 1570. This architecture further facilitates efficient scaling in multiple dimensions (e.g., in a dimension of computing power, in a dimension of storage space, in a dimension of network bandwidth, etc.).

The foregoing virtualized controllers can be implemented in the distributed virtualization environment using various techniques. As one specific example, an instance of a virtual machine at a given node can be used as a virtualized controller in a hypervisor-assisted virtualization environment to manage storage and I/O (input/output or JO) activities. In this case, for example, the virtualized entities at node 1552₁₁ can interface with a controller virtual machine (e.g., virtualized controller 1562₁₁) through hypervisor 1554₁₁ to access storage pool 1570. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 1560. For example, a hypervisor at one node in the distributed storage system 1560 might correspond to software from a first vendor, and a hypervisor at another node in the distributed storage system 1560 might correspond to a second software vendor. As another virtualized controller implementation example, executable containers can be used to implement a virtualized controller (e.g., virtualized controller 1562_{1M}) in an operating system virtualization environment at a given node. In this case, for example, the virtualized entities at node 1552_{1M} can access the storage pool 1570 by interfacing with a controller container (e.g., virtualized controller 1562_{1M}) through hypervisor 1554_{1M} and/or the kernel of host operating system 1556_{1M}.

In certain embodiments, one or more instances of a key-value storage controller 709 (see FIG. 7) can be implemented in the distributed storage system 1560 to facilitate the herein disclosed techniques. Specifically, functions of a key-value storage controller can be implemented as an agent 1504₁₁, which in turn can be implemented in the virtualized controller 1562₁₁, and the functions of a key-value storage controller can be implemented in agent 1504_{1M}, which in turn can be implemented in the virtualized controller 1562_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

As earlier described, the problems attendant to LSM tree architectures that store keys and values together exhibit unwanted performance bottlenecks can be addressed in the context of the foregoing environment. Moreover, any aspect or aspects of architecting the storage of LSM keys into a key storage area optimized for key manipulation and separately storing values into a separate block storage area optimized for value manipulation. can be implemented in in the context of the foregoing environment.

### Additional Details

The herein-disclosed system has the following characteristics:

The system exploits the nature of block management for storing values in a vDisk (i.e., using a separate Block-management component for storage rather than a file). The system enables a parallel write path for better write throughput using a parallel-write and sequential ack protocol. The system performs garbage collection inline to minimize the I/O amplification due to key-value pairs which have not been overwritten/invalidated. The system provides for a recovery path that supports a parallel-write-sequential-ack protocol with keys and values stored separately.

The foregoing exploitation provides the several benefits (1) Write Performance is better since write throughput is improved due to parallel writes. (2) Read Performance is better since there are fewer SSTables, resulting in fewer disk reads and quicker access. (3) Scan Performance is better since there are fewer wasted IOs when there are a lot of overwrites/deletes. Moreover, there are fewer SSTables to scan. (4) Compaction Performance is better since (i) there are fewer SSTables (ii) compaction can be delayed, and (iii) compaction can keep up with heavy write workloads. Also Smaller key-value pairs results in more keys being read in a single IO, which in turn leads to faster compaction. Furthermore, Full block writes in Block store leads to more efficient garbage collection. More specifically, garbage collection of values is much easier and more efficient when the garbage collection is done inline.

### Hyperconverged System Performance:

Any of the foregoing operations can be implemented in the context of a virtualization system. More specifically, the any or all of the foregoing operations can be implemented in a virtualized controller. Various architectures of a virtualized controller are presented hereunder.

### System Architecture Overview

### Additional System Architecture Examples

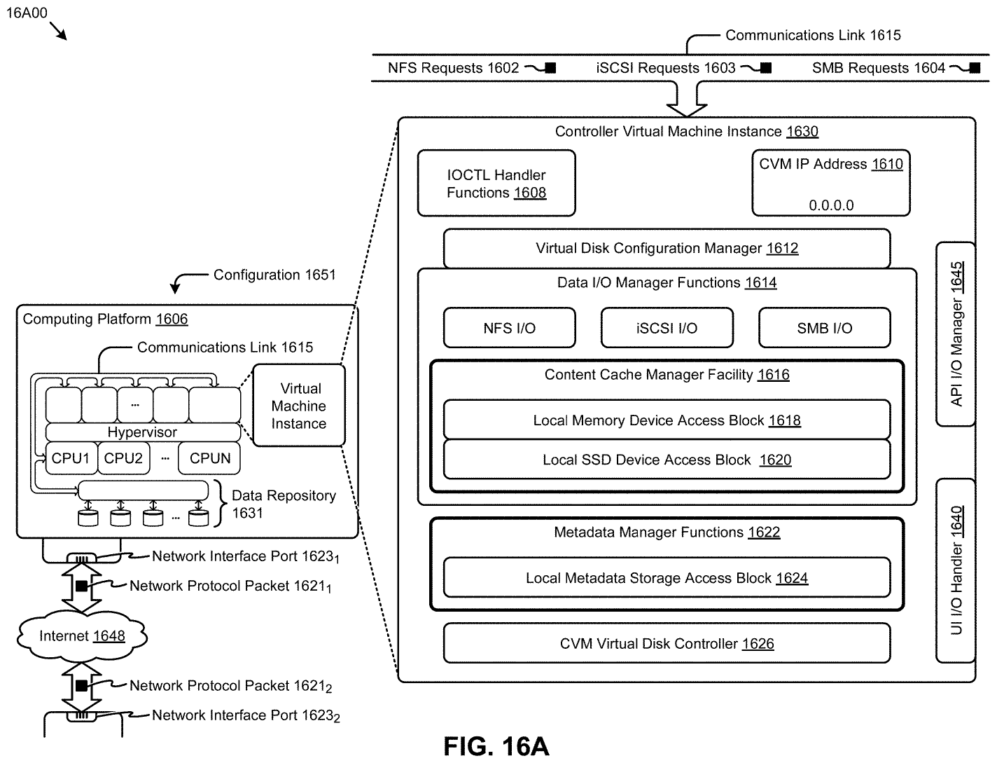

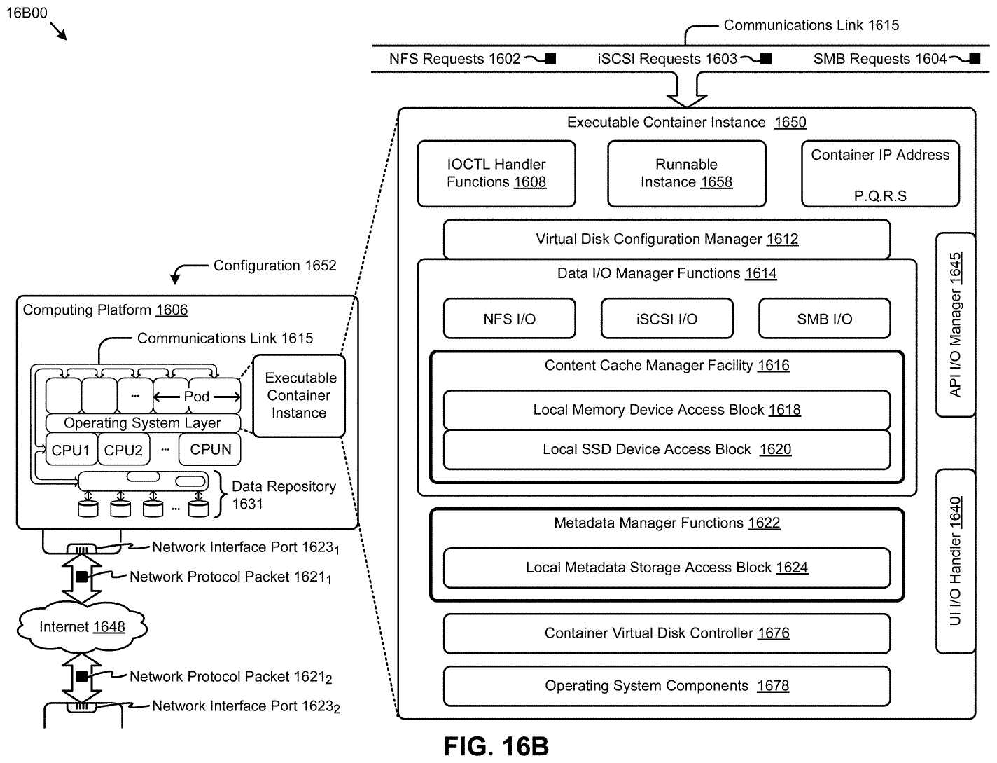

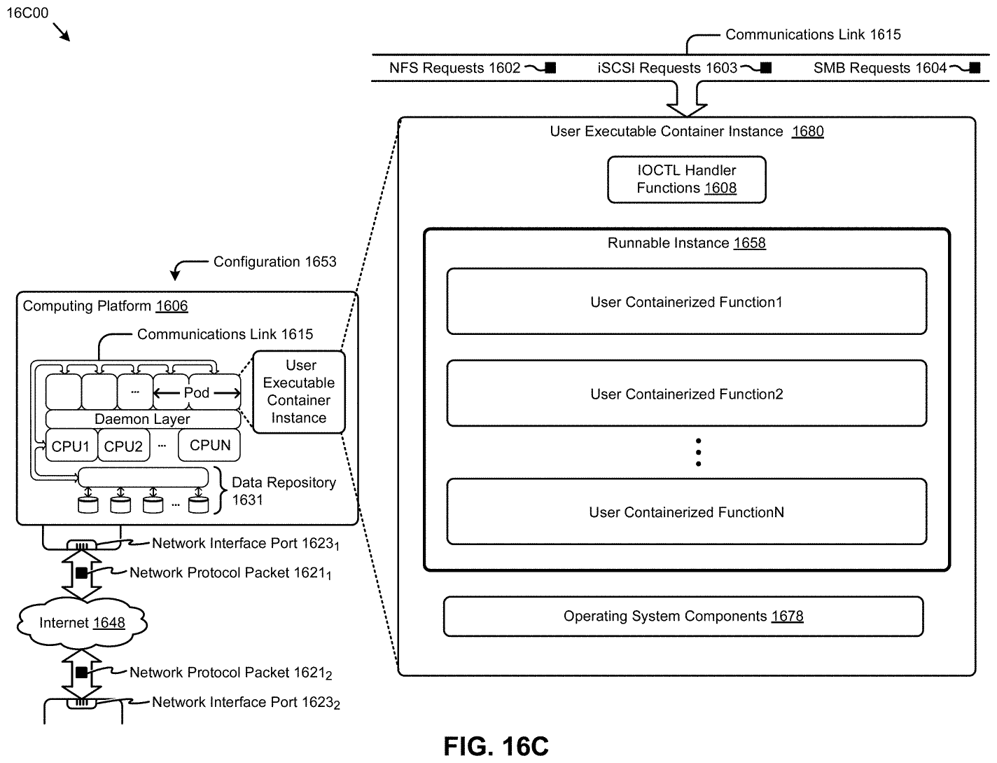

FIG. 16A depicts a virtualized controller as implemented by the shown virtual machine architecture 16A00. The heretofore-disclosed embodiments, including variations of any virtualized controllers, can be implemented in distributed systems where a plurality of networked-connected devices communicate and coordinate actions using inter-component messaging. Distributed systems are systems of interconnected components that are designed for, or dedicated to, storage operations as well as being designed for, or dedicated to, computing and/or networking operations. Interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 16A00 comprises a collection of interconnected components suitable for implementing embodiments of the present disclosure and/or for use in the herein-described environments. Moreover, virtual machine architecture 16A00 includes a virtual machine instance in configuration 1651 that is further described as pertaining to controller virtual machine instance 1630. Configuration 1651 supports virtual machine instances that are deployed as user virtual machines, or controller virtual machines or both. Such virtual machines interface with a hypervisor (as shown). Some virtual machines include processing of storage I/O (input/output or IO) as received from any or every source within the computing platform. An example implementation of such a virtual machine that processes storage I/O is depicted as 1630.

In this and other configurations, a controller virtual machine instance receives block I/O storage requests as network file system (NFS) requests in the form of NFS requests 1602, and/or internet small computer storage interface (iSCSI) block IO requests in the form of iSCSI requests 1603, and/or Samba file system (SMB) requests in the form of SMB requests 1604. The controller virtual machine (CVM) instance publishes and responds to an internet protocol (IP) address (e.g., CVM IP address 1610). Various forms of input and output can be handled by one or more IO control handler functions (e.g., IOCTL handler functions 1608) that interface to other functions such as data IO manager functions 1614 and/or metadata manager functions 1622. As shown, the data IO manager functions can include communication with virtual disk configuration manager 1612 and/or can include direct or indirect communication with any of various block IO functions (e.g., NFS IO, iSCSI IO, SMB IO, etc.).

In addition to block IO functions, configuration 1651 supports IO of any form (e.g., block IO, streaming IO, packet-based IO, HTTP traffic, etc.) through either or both of a user interface (UI) handler such as UI IO handler 1640 and/or through any of a range of application programming interfaces (APIs), possibly through API IO manager 1645.

Communications link 1615 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, controller virtual machine instance 1630 includes content cache manager facility 1616 that accesses storage locations, possibly including local dynamic random access memory (DRAM) (e.g., through local memory device access block 1618) and/or possibly including accesses to local solid state storage (e.g., through local SSD device access block 1620).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 1631, which in turn can be formatted into any one or more storage areas, and which can comprise parameterized storage accessible by a key (e.g., a filename, a table name, a block address, an offset address, etc.). Data repository 1631 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 1624. The data repository 1631 can be configured using CVM virtual disk controller 1626, which can in turn manage any number or any configuration of virtual disks.

Execution of a sequence of instructions to practice certain embodiments of the disclosure are performed by one or more instances of a software instruction processor, or a processing element such as a data processor, or such as a central processing unit (e.g., CPU1, CPU2, . . . , CPUN). According to certain embodiments of the disclosure, two or more instances of configuration 1651 can be coupled by communications link 1615 (e.g., backplane, LAN, PSTN, wired or wireless network, etc.) and each instance may perform respective portions of sequences of instructions as may be required to practice embodiments of the disclosure.

The shown computing platform 1606 is interconnected to the Internet 1648 through one or more network interface ports (e.g., network interface port 1623₁ and network interface port 1623₂). Configuration 1651 can be addressed through one or more network interface ports using an IP address. Any operational element within computing platform 1606 can perform sending and receiving operations using any of a range of network protocols, possibly including network protocols that send and receive packets (e.g., network protocol packet 1621₁ and network protocol packet 1621₂).

Computing platform 1606 may transmit and receive messages that can be composed of configuration data and/or any other forms of data and/or instructions organized into a data structure (e.g., communications packets). In some cases, the data structure includes program instructions (e.g., application code) communicated through the Internet 1648 and/or through any one or more instances of communications link 1615. Received program instructions may be processed and/or executed by a CPU as it is received and/or program instructions may be stored in any volatile or non-volatile storage for later execution. Program instructions can be transmitted via an upload (e.g., an upload from an access device over the Internet 1648 to computing platform 1606). Further, program instructions and/or the results of executing program instructions can be delivered to a particular user via a download (e.g., a download from computing platform 1606 over the Internet 1648 to an access device).

Configuration 1651 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to architecture, system and method to manage I/O performance in log-structured merge trees. In some embodiments, a module may include one or more state machines and/or combinational logic used to implement or facilitate the operational and/or performance characteristics pertaining to architectures, systems and methods to manage I/O performance in log-structured merge trees.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of architecture, system and method to manage I/O performance in log-structured merge trees). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to managing I/O performance in log-structured merge trees, and/or for improving the way data is manipulated when performing computerized operations pertaining to an architecture that facilitates the storage of LSM keys into a key storage area optimized for key manipulation and separately storing values into a separate block storage area optimized for value manipulation.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT”, issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT”, issued on Oct. 1, 2013, which is hereby incorporated by reference in its entirety.

FIG. 16B depicts a virtualized controller implemented by containerized architecture 16B00. The containerized architecture comprises a collection of interconnected components suitable for implementing embodiments of the present disclosure and/or for use in the herein-described environments. Moreover, the shown containerized architecture 16B00 includes an executable container instance in configuration 1652 that is further described as pertaining to executable container instance 1650. Configuration 1652 includes an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification (e.g., “http:”) and possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

The operating system layer can perform port forwarding to any executable container (e.g., executable container instance 1650). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “ls” or “ls-a”, etc.). The executable container might optionally include operating system components 1678, however such a separate set of operating system components need not be provided. As an alternative, an executable container can include runnable instance 1658, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 1676. Such a container virtual disk controller can perform any of the functions that the aforementioned CVM virtual disk controller 1626 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 16C depicts a virtualized controller implemented by a daemon-assisted containerized architecture 16C00. The containerized architecture comprises a collection of interconnected components suitable for implementing embodiments of the present disclosure and/or for use in the herein-described environments. Moreover, the shown daemon-assisted containerized architecture includes a user executable container instance in configuration 1653 that is further described as pertaining to user executable container instance 1680. Configuration 1653 includes a daemon layer (as shown) that performs certain functions of an operating system.

User executable container instance 1680 comprises any number of user containerized functions (e.g., user containerized function1, user containerized function2, . . . , user containerized functionN). Such user containerized functions can execute autonomously or can be interfaced with or wrapped in a runnable object to create a runnable instance (e.g., runnable instance 1658). In some cases, the shown operating system components 1678 comprise portions of an operating system, which portions are interfaced with or included in the runnable instance and/or any user containerized functions. In this embodiment of a daemon-assisted containerized architecture, the computing platform 1606 might or might not host operating system components other than operating system components 1678. More specifically, the shown daemon might or might not host operating system components other than operating system components 1678 of user executable container instance 1680.

The virtual machine architecture 16A00 of FIG. 16A and/or the containerized architecture 16B00 of FIG. 16B and/or the daemon-assisted containerized architecture 16C00 of FIG. 16C can be used in any combination to implement a distributed platform that contains multiple servers and/or nodes that manage multiple tiers of storage where the tiers of storage might be formed using the shown data repository 1631 and/or any forms of network accessible storage. As such, the multiple tiers of storage may include storage that is accessible over communications link 1615. Such network accessible storage may include cloud storage or networked storage (e.g., a SAN or storage area network). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term “vDisk” refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor (e.g., as shown in configuration 1651 of FIG. 16A) to manage the interactions between the underlying hardware and user virtual machines or containers that run client software.

Distinct from user virtual machines or user executable containers, a special controller virtual machine (e.g., as depicted by controller virtual machine instance 1630) or as a special controller executable container is used to manage certain storage and I/O activities. Such a special controller virtual machine is referred to as a “CVM”, or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A computer-implemented method for managing a key-value store comprising:
establishing a key storage area to store keys using a first storage mechanism;
establishing a separate value storage area to store corresponding values using a first storage mechanism;
receiving an update of a value corresponding to a key in the key storage area; and
synchronously updating the key storage area and the separate value storage area to correspond the update with the key.

2. The method of claim 1, wherein the synchronously updating comprises indicating, in the key storage area, a new storage location of the update and reclaiming a portion of the separate value storage area that corresponds to an older value of the key.

3. The method of claim 2, wherein the reclaiming of the portion of the separate value storage area that corresponds to an older value of a particular key is not performed by asynchronous garbage collection acts.

4. The method of claim 2, wherein the update is received from a computing process, and wherein the reclaiming is performed before returning an acknowledgement to the computing process.

5. The method of claim 1, wherein the first storage mechanism operates over a first data structure.

6. The method of claim 5, wherein a second storage mechanism operates over a second data structure that is different from the first data structure.

7. The method of claim 6, wherein the second storage mechanism operates over a second device type.

8. The method of claim 7, wherein the second device type is a block-oriented storage device.

9. The method of claim 1, wherein the first storage mechanism operates over a first device type.

10. The method of claim 9, wherein the first device type is a semiconductor random access memory.

11. A computer-implemented method for managing operations over a log-structured key-value merge tree, the method comprising:
receiving, from a computing process, a new value corresponding to a key in the log-structured key-value merge tree;
storing the new value in a storage area separate from the log-structured key-value merge tree; and
reclaiming a portion of the storage area corresponding to a previous value for the key, wherein the reclaiming is performed before returning an acknowledgement to the computing process.

12. The method of claim 11, wherein the portion of the storage area corresponding to a previous value for the key is a block or a plurality of blocks.

13. A computer-implemented architecture for managing operations over a log-structured key-value merge tree, the architecture comprising:
a block management component that manages a block storage area and performs at least an allocate operation and a free operation over one or more blocks that are (i) addressed by an index value, and that (ii) hold a value portion of the key-value; and
a key management component that stores the key and the index value in a log-structured storage area,
wherein the key management component stores the index value of a block of the block storage area rather than data of the value, and wherein the data of the value is stored in the block storage area rather than in the log-structured storage area, and
wherein, responsive to receiving a command to update a new value that corresponds to a particular key, performing an update of the key storage area and the block storage area in synchronous operations.

14. The architecture of claim 13, wherein performing an update of the key storage area and the block storage area is not performed by asynchronous garbage collection acts.

15. A computer program product, embodied in a non-transitory computer readable medium, the non-transitory computer readable medium having stored thereon a sequence of instructions which, when stored in memory and executed by a processor causes the processor to perform a set of acts for performing inline garbage collection of data storage of a key from a key-value pair, the acts comprising:
receiving the key and a corresponding value;
storing the value in a block storage area and storing the key in a key storage area that is separate from the block storage area;
further receiving, from a computing process, an indication that the value in the block storage area and the key in a key storage area are to be reclaimed; and
reclaiming the data storage of the key, wherein the reclaiming is performed before returning an acknowledgement to the computing process.

16. The computer program product of claim 15, further comprising storing a location of the block storage area that corresponds to a reclaimed key into an in-memory list.

17. The computer program product of claim 15, further comprising merging two sorted string files before returning the acknowledgement to the computing process.

18. The computer program product of claim 15, further comprising identifying a portion of the block storage area corresponding to a reclaimed key to a free pool manager and zeroing out the portion of the block storage area corresponding to the reclaimed key.

19. The computer program product of claim 15, further comprising persisting a portion of the block storage area corresponding to a reclaimed key in a write ahead log.

20. The computer program product of claim 15, further comprising indicating a portion of the block storage area corresponding to the value as cleared bits in a free block bitmap.
